(19) United States
(12) Patent Application Publication
(10) Pub. No.: US 2005/0078383 A1
(43) Pub. Date: Apr. 14, 2005

(54) Plastic, thermally stable, laser diode coupler

(76) Inventors: Edward L. Jones, Cincinnati, OH (US); R. Edward English JR., Cincinnati, OH (US)

Correspondence Address: 3M INNOVATIVE PROPERTIES COMPANY, PO BOX 33427, ST. PAUL, MN, 55133-3427, US

(21) Appl. No.: 10/681,850

(22) Filed: Oct. 8, 2003

(51) Int. Cl. G02B 3/02

(52) U.S. Cl. 359/717

(57) ABSTRACT

An optical system for focusing or collimating light from a semiconductor laser uses a combination of glass and plastic lenses. The glass lens provides a spherical surface for collimating the highly diverging light. The glass lens is relatively inexpensive, and is relatively thermally stable. The plastic lens provides correction for spherical aberration introduced by the glass lens, and may have an aspheric surface. A third lens may be used for focusing the light to a target. The third lens may be glass or plastic. Since the optical power of the plastic lens is low, the overall performance of the optical system is thermally stable, despite the use of plastic components.

### FIELD OF THE INVENTION

The invention relates to semiconductor lasers, and more particularly to an optical system for refracting light emitted from a laser.

### BACKGROUND

Light emitted by semiconductor lasers typically diverges from the laser with a large angle in at least one dimension, due to the small size of the semiconductor waveguide in which the light is generated within the laser. This results in the need for strong focusing optical components for collimating or for focusing the light from the laser. One particularly important application of semiconductor lasers is to focus the light into an optical fiber. Where the fiber is a single mode fiber, the light has to be focused down to a spot of a few microns in diameter in order to efficiently couple the light into the single mode waveguide of the fiber.

This need for tight focusing places strict requirements on the focusing system used to focus the light from the semiconductor laser. The focusing system should be able to focus sufficiently tightly as to ensure that a substantial fraction of the light overlaps with the single mode of the fiber for efficient coupling. This requires that the focusing system introduce little aberration to the light being focused. In addition, many applications require that the focusing system should be able to operate in a stable manner over a wide temperature range. Also, it is desirable that the focusing system be inexpensive so as to reduce costs.

### SUMMARY OF THE INVENTION

The present invention is directed to the use of a combination of glass and plastic lenses, the glass lens providing a spherical surface for collimating the highly diverging light and the aspheric plastic lens providing correction for spherical aberration introduced by the glass lens.

In one particular embodiment of the invention, a light emitting unit comprises a light source emitting a beam of output light; and a refractive optical unit disposed in the beam of output light. The refractive optical unit comprises a first lens formed of glass and having at least one spherical refracting surface. The first lens reduces the divergence of the output light from the light source. A second lens is formed of plastic and has a first refracting surface having a refractive characteristic that substantially compensates spherical aberration introduced by the first lens.

Another embodiment of the invention is directed to a lens assembly for managing light. The assembly comprises a first lens formed of glass having a spherical refracting surface. A second lens is formed of plastic and is disposed to receive light from the first lens. The second lens has a refractive characteristic that substantially compensates spherical aberration introduced by the first lens.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a light emitting system employing an embodiment of a lens assembly according to principles of the present invention;

FIG. 2A presents a graph showing coupling loss as a function of operating temperature for a plastic collimating lens and for a lens assembly fabricated according to principles of the present invention;

FIG. 2B presents a graph showing coupling loss as a function of numerical aperture for a purely spherical focusing system and for a lens assembly according to the principles of the present invention;

FIG. 3 presents a graph showing laser coupling loss as a function of the distance between the components of a lens assembly fabricated according to principles of the present invention;

FIGS. 4-7 schematically illustrate light emitting systems employing other embodiments of a lens assembly according to principles of the present invention;

FIG. 8 presents a graph showing laser coupling loss as a function of temperature for a lens assembly fabricated according to principles of the present invention having an integrated plastic corrector lens and focusing lens;

FIGS. 9A and 9B schematically present orthogonal views of an embodiment of a light emitting system having different lenses for reducing the divergence of light in different propagation planes, according to principles of the present invention; and

FIG. 9C schematically presents a view of another embodiment of a light emitting system having different lenses for reducing the divergence of light in different propagation planes, according to principles of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to optical systems and is more particularly applicable to lens systems that collimate, focus or otherwise change the divergence of light emitted from lasers such as semiconductor lasers.

It is desirable to use inexpensive components in the lens system used to collimate, focus or otherwise change the divergence of light emitted from a laser. Spherical glass lenses, in other words glass lenses that have at least one spherical refracting surface are relatively inexpensive. Spherical lenses need not actually take on the shape of a sphere, but only require that the curved refracting surfaces, or surface, conform(s) to a spherical surface. Cylindrical lenses have at least one refracting surface that conforms to a cylindrical surface.

Due to the high divergence of light emitted from semiconductor lasers, however, it is common to use ball lenses, in the shape of a sphere; half ball lenses, in the shape of a hemisphere; or cylindrical lenses, in the shape of a cylindrical rod, for reducing the divergence of light emitted from a semiconductor laser. Spherical and cylindrical lenses, however, introduce spherical aberrations that reduce the ability of the lens system to efficiently focus a target, such as the input end of an optical fiber. Glass lenses having aspherical or acylindrical surfaces operate with reduced spherical aberration but are more expensive to fabricate than spherical or cylindrical lenses. For the purposes of this description, the term “spherical”, when applied to a refracting surface or lens refers to a refracting surface or lens that can introduce spherical aberration, including lenses having surfaces that conform to a sphere or to a cylinder.

Plastic lenses are relatively inexpensive to mold, whether they have spherical or aspherical surfaces. Plastic lenses, however, are significantly more subject to thermal changes than glass lenses, and so a lens system having plastic lenses may demonstrate characteristics that are significantly temperature dependent.

An approach used in the present invention to maintain low aberration while still maintaining good temperature dependence and low cost is to use an assembly having a glass spherical lens and a plastic corrector lens that corrects the spherical aberration in the glass spherical lens. This permits the use of a relatively inexpensive spherical glass lens to provide most of the optical power, and permits the use of an inexpensive plastic lens to reduce aberration. Since most of the optical power is provided by the glass lens, the assembly shows little temperature dependence.

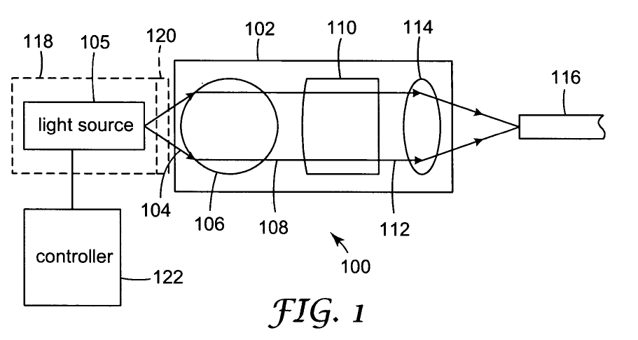

One particular embodiment of a light emitting unit 100 that uses a lens assembly 102 for changing the divergence of light emitted from a light source such as a semiconductor laser is schematically illustrated in FIG. 1. Diverging light 104 is emitted from the light source 105, which may be a laser such as a semiconductor laser. The divergence of the light 104 is reduced using a first lens 106. In the illustrated embodiment, the first lens 106 substantially collimates the light 104. One type of spherical lens that may be used is a spherical ball lens, as illustrated. The first lens 106 may be formed from any suitable type of glass, for example silica glasses, fused silica, and the like. More specifically, ball lenses, half ball lenses and cyindircal lenses are available from Schott Glass, Germany, in a variety of glasses, including BK7, SFL56, NBALF4, LASF35, LASFN9, N-LASF44, N-LAFF33, and fused silica. Ball lenses are also available in other transparent inorganic materials such as sapphire. Lenses formed from glass or sapphire may be referred to as inorganic lenses since they are made from inorganic materials.

It will be appreciated that, although the term “collimated” is used to denote light that is propagating with little divergence or convergence, there are physical limits on how small the divergence can be, and that values of divergence cannot be smaller than the diffraction limited value. Accordingly, the term “collimated” is used here to cover light whose divergence or convergence is small, for example, less than 10 milliradians, and maybe less than 5 milliradians, but is not necessarily at the diffraction limit.

The collimated light 108 passes through a second lens 110, which may be referred to as a corrector lens. The second lens 110 has a refractive characteristic that at least partially compensates for the spherical aberration introduced by the first lens. For example, the second lens 110 has an aspheric refracting surface that compensates, at least partially if not fully, for the spherical aberration of the first lens, so that the light 112 exiting the second lens 110 is substantially free of spherical aberration. The second lens 110 typically has little optical power, and therefore has little, or no, effect on the divergence of the collimated light 108.

The second lens 110 may be formed from a plastic material, such as a polymer. For example polycarbonate, acrylic, cyclic olefin copolymer, polystyrene and styrene copolymers, such as NAS®, available from Nova Chemicals Corp, Pittsburgh, Pa., may be used for visible light, and may also be used for other wavelengths. Polyetherimide, available from GE Plastics, Brea CA, under the trade name Ultem®, is a plastic material that is commonly used for infrared light. The plastic material may conveniently be molded to the desired shape.

The collimated light 108 may then be focused using a third lens 114, or a combination of a third lens 114 and additional lenses, to an optical fiber 116, which may be a single mode fiber.

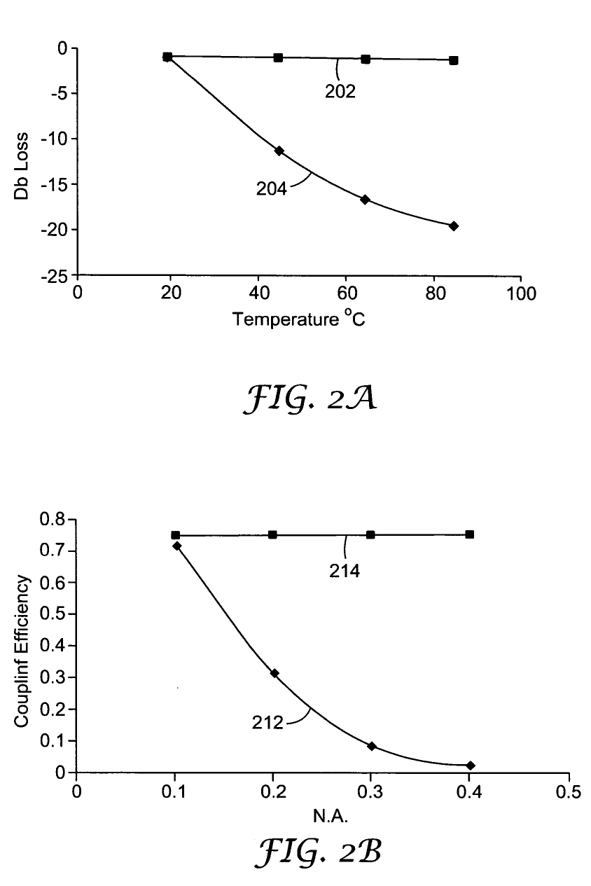

A graph comparing the calculated optical coupling efficiency of the lens assembly 102 with that of an entirely plastic lens system is shown in FIG. 2A. Curve 202 shows the calculated coupling efficiency between a laser and an optical fiber using a lens assembly such as lens assembly 102 as a function of operating temperature. The lens assembly was assumed to include a glass ball lens for collimating, a plastic corrector lens formed from Ultem, and a glass ball lens for focusing into the fiber. Curve 204 shows the calculated coupling efficiency for a lens assembly that had a ball collimator lens and corrector lens formed from Ultem, and a glass ball lens for focusing into the fiber. The lens assembly having the plastic collimator demonstrates a significant drop in the coupling efficiency as the operating temperature is increased from 20° C. to 80° C. On the other hand, the coupling efficiency shown in curve 202 is substantially independent of temperature.

Another graph, showing the calculated coupling efficiency for a purely spherical focusing system and a system having correction for spherical aberration is presented in FIG. 2B. For each curve, light was assumed to emerge from a source having the numerical aperture (N.A.) as shown as the x-co-ordinate. The light was collimated using a first BK7 ball lens and then focused using a second BK7 ball lens to a fiber target having an N.A. of 0.1. For curve 212, there was no correction for spherical aberration. As can be seen, there is significant coupling loss for sources emitting light with an N.A. of more than 0.1. In curve 214, the focusing system included a plastic corrector lens positioned between the two ball lenses to compensate for the spherical aberration introduced by the first (collimating) ball lens. The coupling efficiency was essentially flat for values of source N.A out to 0.4. This demonstrates the importance of correcting for spherical aberration when the N.A. of the source is high, for example higher than 0.1.

Typically, where the light source 105 is a semiconductor laser, the numerical aperture of the optical fiber 116 is less than that of the semiconductor laser, and so the optical power of the third lens 114 is less than the optical power of the first lens 106. Accordingly, the third lens 116 may be formed from glass or from a plastic material.

The light source 105, such as a laser, may be contained within a housing 118 having a window 120 or aperture to transmit the light 104. The housing 118 may also encompass the lens assembly 102. The input end of the fiber 116 may also be disposed within the housing 118.

A controller unit 122 may be used to control the light source 105. The controller unit 122 may be used to provide a drive current to operate the light source 105. The controller unit 122 may also stabilize the temperature of the light source 105. Where the light source 105 is a laser, temperature stabilization, for example through active cooling or heating, may be useful to maintain a constant output wavelength. The controller unit 122 may also tune the light source 105 to a desired wavelength if the light source 105 is tunable.

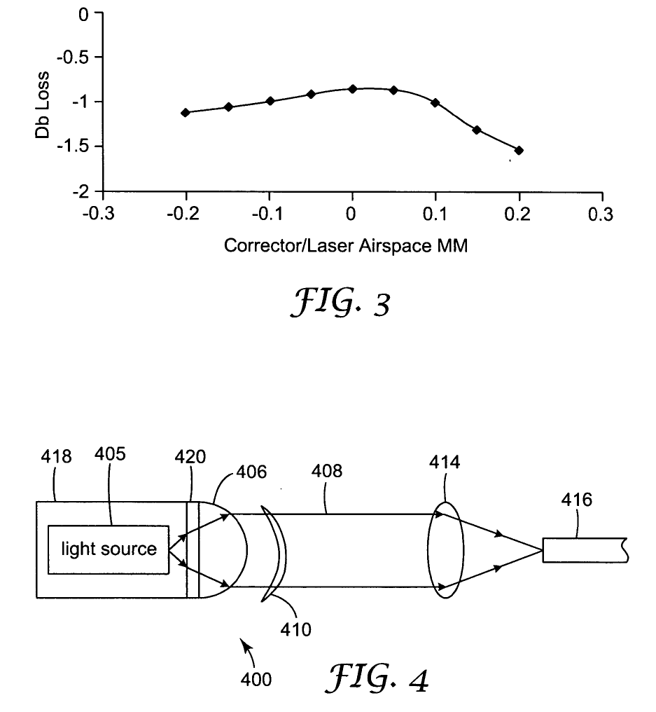

The relative separation between the first lens 106 and the second lens 110 is not very critical for efficient operation of the lens assembly 102. FIG. 3 presents a graph showing coupling loss into a fiber as a function of the size of the air space between the first and second lenses 106 and 110. As can be seen, the coupling efficiency is fairly flat over a range of at least 300 μm. The zero point is taken as being the nominal air space for the particular system. As a result, changes in the size of the air space between the first and second lenses, for example due to manufacturing tolerances or changes due to temperature, do not result in significant changes in the coupling efficiency.

Another embodiment of a light emitting system 400 is schematically illustrated in FIG. 4. In this embodiment, the glass first lens 406 is a half ball lens, in the shape of a hemisphere, and the first lens 406 collimates the light 404 emitted from the light source 405. The first lens 406 may be any type of spherical lens including, for example, a ball lens, a half ball lens, a plano-convex lens, a biconvex lens or a meniscus lens.

The collimated light 408 passes through the plastic second lens 410, which corrects for the spherical aberration of the first lens 406. In the illustrated embodiment, the second lens 410 is a meniscus lens. It will be appreciated that the second lens 410 may be formed in one of a number of different geometries while still correcting for the spherical aberration. The collimated light 408 may be focused to a fiber 416 using a third lens 414.

The light source 405, such as a laser, may be contained within a housing 418, as illustrated, having a window 420. The first lens 406 may be attached to the window 420, or may be separate from the window. The housing 418 may also encompass the lens assembly, comprising the first second and/or third lenses 406, 410 and 414. Furthermore, the input end of the fiber 416 may also be included within the housing 405.

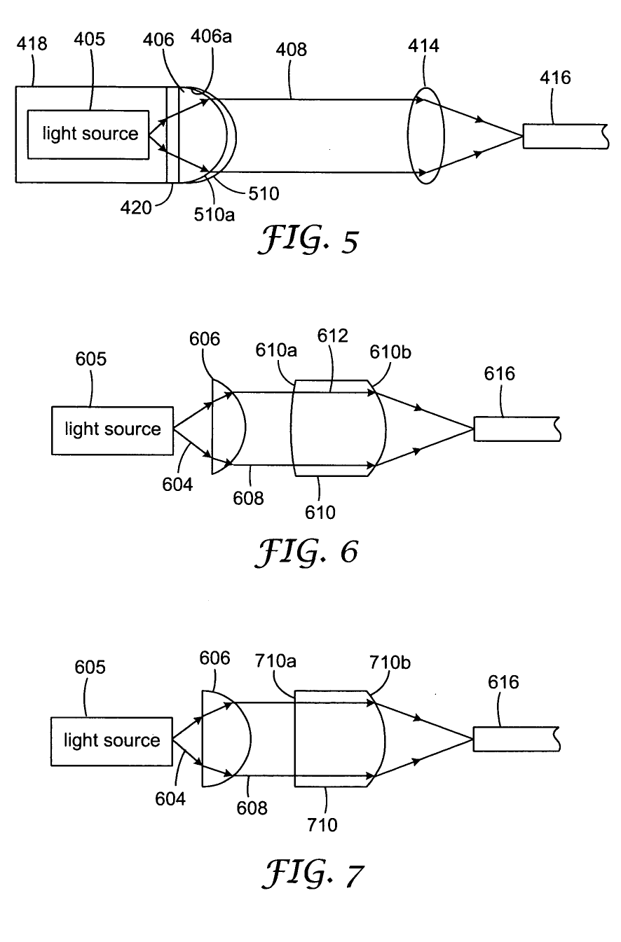

In another embodiment, a plastic meniscus second lens 510 may be attached to the glass first lens 406, as is schematically illustrated in FIG. 5. In such a case, it may be preferable that the second surface 406a of the first lens has a radius of curvature substantially the same as the radius of curvature of the first surface 510a of the meniscus second lens 510. This matching of the radii of curvature results in a close fit between the first and second lenses 406 and 510. The second lens 510 may be attached to the first lens 406 using any suitable type of adhesive that transmits light, for example, an optical epoxy or the like. A result of this embodiment, where the second lens 510 is attached to the first lens 406, is that the coma of the lens assembly is reduced, Consequently, deleterious effects that arise from placing the laser 405 off the axis of the lens assembly are reduced. This means that manufacturing tolerances in a system that uses this embodiment of lens assembly are less stringent, and may permit the laser to be passively aligned relative to the lens assembly, rather than being actively aligned.

In another embodiment, schematically illustrated in FIG. 6, the glass first lens 606, shown here as a plano-convex spherical lens, substantially collimates the light 604 from the light source 605. The collimated light 608 passes into a plastic second lens 610 that has two non-planar refracting surfaces 610a and 610b. The plastic second lens 610 may be a molded lens. The first non-planar refracting surface 610a is an aspherical surface for correcting the spherical aberration introduced in the light 608 by the first lens 606, so that the light 612 propagating within the second lens 610 is substantially free of spherical aberration. The second non-planar refracting surface 610b is a focusing surface that focuses the light 608 to the target, in this case an optical fiber 616. The second non-planar refracting surface 610b may be spherical or aspherical. Thus, the second lens 610 may be used both to correct for spherical aberration and to focus the light to a target. The first non-planar refracting surface 610a may also be used to correct for aberration, such as spherical aberration, arising in the second non-planar refracting surface 610b.

One of the refracting surfaces of the second lens may both correct for the spherical aberration and focus the light, as is schematically illustrated in FIG. 7. In this embodiment, the second surface 710b of the second lens 710 is aspherical and both focuses the collimated light 608 to the fiber 616, and may also correct for the spherical aberration introduced in the light 608 by the first lens 606. The first surface 710a of the second lens may be flat.

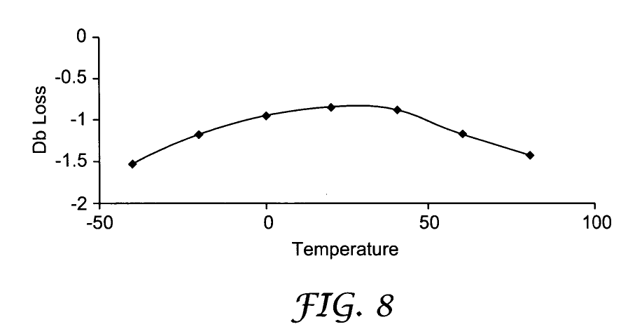

Since the numerical aperture of the plastic second lens 610 is significantly less than that of the glass first lens 606, the plastic second lens 610 does not introduce significant temperature dependence to the lens assembly. FIG. 8 presents a graph showing the calculated coupling loss between a laser and an optical fiber as a function of temperature, where the corrector lens and the third, focusing, lens are both formed of plastic. The coupling loss remains below 1 dB over a range from about 0° C. to about 50° C., and below 1.5 dB from about −40° C. to about 90° C.

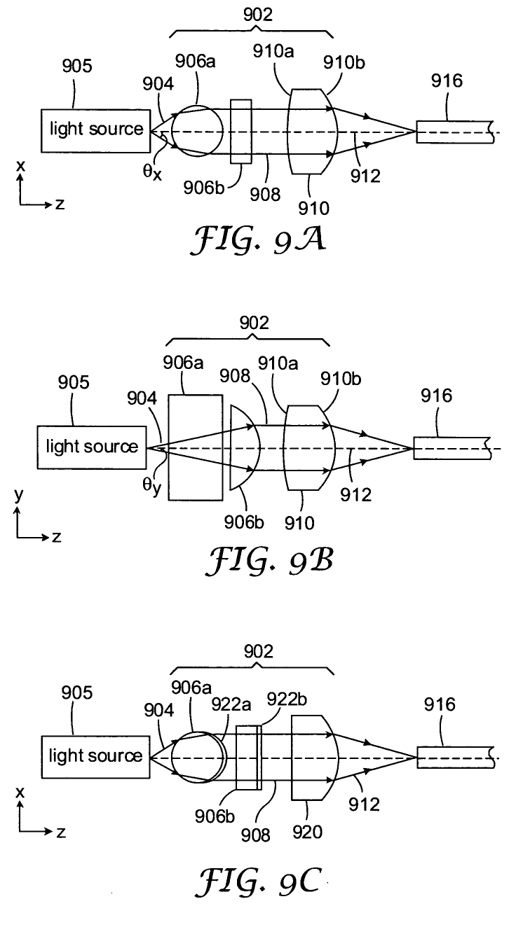

The corrector lens need not be rotationally symmetric. A corrector lens that is not rotationally symmetric may be useful when the light is emitted from the light source with different angles of divergence in different divergent planes. Some types of semiconductor laser emit light with different divergence angles in different divergent planes, as is now explained with respect to FIGS. 9A and 9B which show orthogonal schematic views of a light unit 905 having a lens assembly 902. In FIG. 9A, the light 904 diverges in the x-z propagation plane with a half angle θₓ, while the light 904 diverges in the y-z propagation plane with a half angle θ_{y}, as shown in FIG. 9B. The divergence in the x-z propagation plane is greater than in the y-z propagation plane, so θₓ>θ_{y}, and the x-axis and y-axis are typically referred to as the fast-axis and the slow axis respectively.

The asymmetrically diverging light 904 from the light source may be collimated using one or more lenses. In the illustrated embodiment, the light 904 from the light source 905 is collimated using two different lenses. Lens 906a is used to collimate the light in the x-z plane, and lens 906b is used to collimate the light in the y-z plane. Lenses 906a and 906b may be cylindrical or toroidal lenses. The use of such an arrangement, with two collimating lenses 906a and 906b positioned at different points along the optical axis 912 from the light source 905, permits the collimated beam to 908 have the same dimension in the x-direction as the y-direction.

The collimated light 908 may be corrected for aberration using a corrector lens. Any of the different types of corrector lens discussed herein may be used. In the illustrated embodiment, the lens 910 includes a correcting surface 910a and a focusing surface 910b to focus the light to the target 916. The correcting surface 910a may correct for spherical aberration arising in lenses 906a and 906b, and may also correct for spherical aberration arising in the focusing surface 910b. Since lenses 906a and 906b have different optical powers, the correcting surface 910a may have an asymmetric correcting profile, and so the correcting surface 910a may not be rotationally symmetric about the optical axis 912.

The correcting lens need not be integrated with a focusing lens, but may be separate from the focusing lens. Furthermore, there may be respective correcting lenses provided along the optical axis for each of the lenses 906a and 906b, where each correcting lens provides correction for spherical aberration in the propagation plane in which the associated lens reduces the divergence of the light, as is schematically shown in FIG. 9C. For example, each of the lenses 906a and 906b may be provided with respective correcting lenses 922a and 922b attached to their output surfaces, in a manner similar to that illustrated in FIG. 5, but where the correcting lens 922a and 922b is operative only in the associated propagation plane. The collimated light 908 is focused to the target using a plastic focusing lens 920.

As was noted above, the present invention is believed to be particularly applicable to focusing systems for semiconductor lasers. It will be appreciated, however, that the present invention is also applicable to other situations where highly divergent light is to be collimated and focused inexpensively, but without aberration and with low temperature dependence, and is not restricted to use with only semiconductor lasers.

It will be appreciated that the lens assembly, and light emitting systems using such lens assemblies need not be restricted only to those embodiments illustrated. For example, the first lens need not collimate the light from the light source. The light passing from the first lens may also be diverging, or may be converging. Furthermore, it will be appreciated that various optical surfaces of the lenses in the lens assemblies may be coated with anti-reflection coatings to reduce reflective losses. In addition, the target to which the light is focused need not be an optical fiber. The lens assembly may be used with different types of light source, operating at different wavelengths. The lenses used in the lens assembly may be designed and positioned appropriately for the desired operating wavelength.

Accordingly, the present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

1. A light emitting unit, comprising:
a light source for emitting a beam of output light; and
a refractive optical unit disposed in the beam of output light, the refractive optical unit comprising
a first lens formed of inorganic material and having a refracting surface that produces spherical aberration, the first lens being disposed so as to reduce the divergence of the beam of output light from the light source, and
a second lens formed of plastic and disposed in the beam of output light, the second lens having a refractive characteristic that substantially compensates spherical aberration introduced by the first lens.

2. A unit as recited in claim 1, wherein the light source is a laser.

3. A unit as recited in claim 2, wherein the laser is a semiconductor laser.

4. A unit as recited in claim 1, wherein the inorganic material is glass.

5. A unit as recited in claim 1, wherein the first lens is disposed at a distance from the light source so that the beam of output light is substantially collimated after passing through the first lens.

6. A unit as recited in claim 1, wherein the first lens is a ball lens.

7. A unit as recited in claim 1, wherein the first lens is a half ball lens.

8. A unit as recited in claim 1, wherein the second lens has an aspheric refracting surface.

9. A unit as recited in claim 8, wherein the aspheric refracting surface is non-rotationally symmetric about an optical axis of the refractive optical unit.

10. A unit as recited in claim 1, wherein the second lens is a molded plastic lens.

11. A unit as recited in claim 1, further comprising a third lens, the third lens disposed in the light beam to focus light that has passed through the first and second lens from the light source.

12. A unit as recited in claim 11, wherein the second lens has a refractive characteristic that substantially compensates spherical aberration introduced by the first lens and by the third lens.

13. A unit as recited in claim 1, wherein the second lens comprises a first surface shaped to correct for spherical aberration arising in the first lens, and a second surface shaped to focus the beam of output light.

14. A unit as recited in claim 13, wherein the first surface has a refractive characteristic that substantially compensates spherical aberration introduced by the first lens and by the second surface of the second lens.

15. A unit as recited in claim 1, wherein the second lens comprises a first surface, the first surface being shaped to correct for spherical aberration arising in the first lens and to focus the spherical aberration-corrected light.

16. A unit as recited in claim 1, wherein the second lens is a meniscus lens.

17. A unit as recited in claim 16, wherein the meniscus lens is attached to the refracting surface of the first lens.

18. A unit as recited in claim 1, wherein the second lens is attached to the refracting surface of the first lens.

19. A unit as recited in claim 1, further comprising a controller unit connected to the light source.

20. A unit as recited in claim 1, wherein the light source is disposed within a housing having a window, the first lens being attached to the window.

21. A unit as recited in claim 1, wherein the output light has a divergence of less than 10 milliradians after passing through the first lens from the light source.

22. A unit as recited in claim 1, wherein the output light has a divergence of less than 5 milliradians after passing through the first lens from the light source.

23. A unit as recited in claim 1, wherein the first lens comprises a plurality of first lenses disposed to reduce the divergence of the beam of output light from the light source.

24. A unit as recited in claim 23, wherein the plurality of first lenses comprises at least one lens disposed to reduce divergence of the output beam light in a first propagation plane and at least one lens disposed to reduce divergence of the output beam of light in a second propagation plane orthogonal to the first propagation plane.

25. A unit as recited in claim 24, wherein the second lens comprises a refractive correcting surface that corrects spherical aberration introduced by the at least one lens disposed to reduce divergence of the output beam light in the first propagation plane and by the at least one lens disposed to reduce divergence of the output beam of light in the second propagation plane.

26. A unit as recited in claim 24, wherein the second lens comprises a plurality of second lenses, one of the second lenses correcting spherical aberration introduced by the at least one lens disposed to reduce divergence of the output beam light in the first propagation plane and another of the second lenses correcting spherical aberration introduced by the at least one lens disposed to reduce divergence of the output beam of light in the second propagation plane.

27. A unit as recited in claim 26, wherein the second lenses are attached to their respective first lenses.

28. A lens assembly for managing light, the assembly comprising:
a first lens formed of an inorganic material and having a spherical refracting surface, the first lens being disposed on a optical axis of the assembly; and
a second lens formed of plastic and disposed on the optical axis, the second lens having a refractive characteristic that substantially compensates spherical aberration introduced by the first lens.

29. An assembly as recited in claim 28, wherein the first lens is a ball lens.

30. An assembly as recited in claim 28, wherein the first lens is a half ball lens.

31. An assembly as recited in claim 28, wherein the second lens has an aspheric refracting surface.

32. An assembly unit as recited in claim 31, wherein the aspheric refracting surface is non-rotationally symmetric about an optical axis of the assembly.

33. An assembly as recited in claim 28, wherein the second lens is a molded plastic lens.

34. An assembly as recited in claim 28, further comprising a third lens, the third lens disposed to focus light that has been collimated by the first and second lenses.

35. An assembly as recited in claim 34, wherein the second lens comprises a first surface shaped to correct for spherical aberration arising in the first lens, and a second surface shaped to focus spherical aberration-corrected light received from the first surface.

36. A laser unit as recited in claim 28, wherein the second lens comprises a first surface shaped to correct for spherical aberration arising in the first lens and shaped to focus spherical aberration-corrected light received from the first surface.

37. An assembly as recited in claim 28, wherein the second lens is a meniscus lens.

38. An assembly as recited in claim 37, wherein the meniscus lens is attached to the spherical refracting surface of the first lens.

39. An assembly as recited in claim 28, wherein the second lens is attached to the spherical refracting surface of the first lens.

40. An assembly as recited in claim 28, wherein the first lens comprises at least a hemisphere of glass and the second lens is a meniscus lens attached to the spherical refracting surface of the first lens.

41. A unit as recited in claim 28, wherein the first lens comprises a plurality of first lenses.

42. A unit as recited in claim 41, wherein the plurality of first lenses comprises at least one lens disposed to reduce divergence of light in a first propagation plane and at least one lens disposed to reduce divergence of light in a second propagation plane orthogonal to the first propagation plane.

43. A unit as recited in claim 42, wherein the second lens comprises a refractive correcting surface that corrects spherical aberration introduced by the at least one lens disposed to reduce divergence of light in the first propagation plane and by the at least one lens disposed to reduce divergence of light in the second propagation plane.

44. A unit as recited in claim 42, wherein the second lens comprises a plurality of second lenses, one of the second lenses correcting spherical aberration introduced by the at least one lens disposed to reduce divergence of light in the first propagation plane and another of the second lenses correcting spherical aberration introduced by the at least one lens disposed to reduce divergence of light in the second propagation plane.

45. A unit as recited in claim 44, wherein the second lenses are attached to their respective first lenses.
